(19) United States
(12) Patent Application Publication
(10) Pub. No.: US 2010/0073566 A1
(43) Pub. Date: Mar. 25, 2010

(54) ON-SCREEN DISPLAY METHOD AND A DISPLAY DEVICE USING THE SAME

(75) Inventors: Michael Frederick Wedemeier, Richardson, TX (US); Umesh G. Jani, Plano, TX (US); Anne E. French, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/235,619

(22) Filed: Sep. 23, 2008

(51) Int. Cl. H04N 5/50; H04N 7/12

(52) U.S. Cl. 348/569; 375/240.25; 348/E05.097; 375/E07.027; 709/230

(57) ABSTRACT

On-screen-display contents are displayed by sending abstracted information of the on-screen-display contents to a data handler of the display device. The data handler translates the abstracted information and passes the translated information to an on-screen-display decoder. The on-screen-display decoder composes the on-screen-display contents using the translated information. The composed on-screen-display contents are displayed on a screen of the display device.

### TECHNICAL FIELD OF THE DISCLOSURE

The technical field of this disclosure relates to the art of display devices, and more particularly to the art of methods of presenting on-screen-display content in display devices and display devices having said capabilities.

### BACKGROUND OF THE DISCLOSURE

Current display devices such as projectors, television receivers display on-screen-display contents by embedding on-screen-display contents in the video streams or by storing on-screen-display contents in a storage of the display devices and displaying the stored on-screen-display contents by retrieving the on-screen-display contents from the storage and displaying the contents. Dynamic on-screen-display presentation with these techniques adds system design cost, manufacturing cost, and material cost.

Therefore, what is desired is a method of displaying on-screen-display contents and a display device having dynamic on-screen-display capability.

### SUMMARY

In one example, a method for displaying an on-screen-content in a display device is disclosed herein, the method comprising: obtaining an abstracted information of the on-screen-display content such that the abstracted information has a data size that is equal to or smaller than the data size of the on-screen-display content; delivering the abstracted information to the display device; building the on-screen-display content from the abstracted information; and displaying the built on-screen-display content on a screen.

In another example, a method for use in a network that comprises first and second display devices that are at different physical locations and are connected to the network is disclosed herein. The method comprises: delivering first and second on-screen-display contents to the first and second display device, wherein the first and second on-screen-display content are not carried by and are separate from video signals being displayed by the first or the second display device; and displaying the first and second on-screen-display contents by the first and the second display devices.

In yet another example, a system is provided, the system comprising: a display device, comprising: a video decoder capable of receiving a stream of video signals to be displayed and decoding the stream of video signals; a data handler capable of receiving an on-screen-display content from an external data source; a multiplexer connected to an output of the video decoder and an output of the data handler; and an on-screen-display data logic connected to an output of the multiplexer.

### BRIEF DESCRIPTION OF DRAWINGS

FIG. 1 diagrammatically illustrates a portion of an exemplary display device capable of displaying dynamic on-screen-display contents;

FIG. 2 diagrammatically illustrates a portion of an exemplary display device capable of display on-screen-display contents received over a network;

FIG. 3a diagrammatically illustrates exemplary structures of the Ethernet controller and the micro-logic in the display device in FIG. 2;

FIG. 3b shows a standard network stack implemented in the Ethernet controller and the micro-logic in FIG. 3a;

FIG. 4 is a flow chart of an exemplary operation of displaying on-screen-display contents using display devices in FIG. 1 and FIG. 2;

FIG. 5 diagrammatically illustrates a network system in which the display device of FIG. 2 can be a member;

FIG. 6 is an exemplary evacuation floor plan of a campus building to be displayed as an on-screen-display content in network-connected display devices in the campus building;

FIG. 7 is an exemplary on-screen-display displayed in one of the class-rooms in the campus building;

FIG. 8 is an exemplary on-screen-display displayed in another one of the class-rooms in the campus building; and

FIG. 9 diagrammatically illustrates a display device capable of displaying captions of a video, wherein the caption is user-selected over the network and is different from the embedded captions in the received video signals.

### DETAILED DESCRIPTION OF SELECTED EXAMPLES

Disclosed herein is method of displaying on-screen-display content in a display device by delivering abstracted information of the on-screen-display content to the display device. The display device re-composes the on-screen-display content based upon the abstracted information of the on-screen-display contents; and displays the composed on-screen-display contents. Because the abstracted information of the on-screen-display content has a much smaller size than the actual on-screen-display content, the connection between the display device and the external on-screen-content source can be allowed to use low-speed interface/connections, which in turn reduces the cost of the system design and manufacture. Due to the smaller data size, the abstracted on-screen-content information can be transmitted from external on-screen-display sources to the display device with significantly increased efficiency and accuracy.

As used herein, a display device primarily functions to display video and image. The examples of display devices in this disclosure still retain this primary function but have added capabilities that will be detailed in the following with selected examples. The display device can be any suitable device, such as a projector, a rear-projection television, a flat-panel display system, or a display unit in an electronic device, such as a hand-held device, a personal-digital-assistant (PDA) device, a cell-phone, or other electronic device having display functions.

A logic or a micro-logic is referred to as a functional module capable of performing digital signal processing, especially logic operation on input digital signals. A logic can be in a form of an electronic circuit (e.g. a microprocessor or a micro-controller) or a set of executable codes stored in a medium.

It will be appreciated by those skilled in the art that the following discussion is for demonstration purposes and should not be interpreted as a limitation. Other variations within the scope of this disclosure are also applicable.

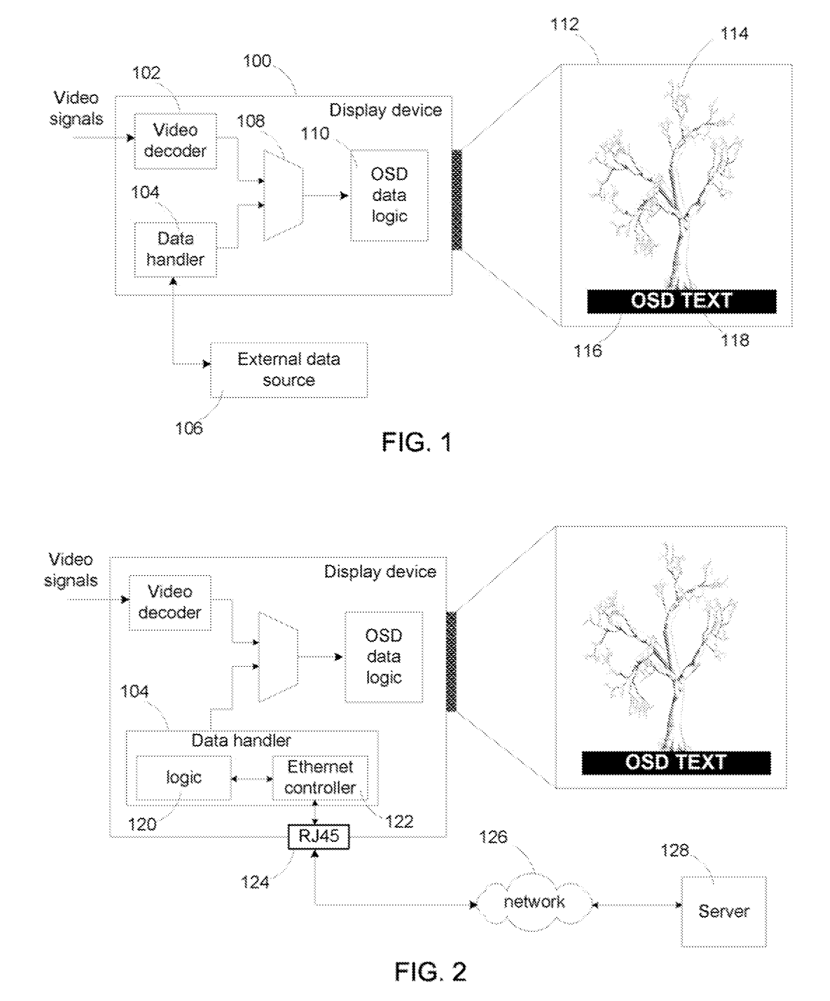

Referring to the drawings, FIG. 1 diagrammatically illustrates a portion of an exemplary display device. For demonstration purposes, only a portion of the display device is shown in the figure. Other functional components, such as an illumination system providing illumination light for the system, optics for directing illumination light within the display device, a light valve for displaying video/images based on video/image data, video/image data logic(s), input-output ports, audio processing units, and other functional components can be provided in the display device.

In the examples as shown in FIG. 1, video decoder 102 of display device 100 receives video signals from an external video source. The video streams can be received from for example, a television program broadcasting services (e.g. a cable TV provider) or other video sources, such as a video camera, a DVD/VCD/Blu-ray player, a digital receiver, a computer, or any electronic devices capable of outputting video signals. The video decoder can extract the video captions and/or on-screen-display contents that are embedded in the video streams; and decode the video caption and/or the on-screen-display content. The decoded video captions and/or on-screen-display contents are forwarded to an input of multiplexer 108.

Data handler 104 of the display device (100) is connected to one or more external data sources, such as external data source 106, in which on-screen-display contents can be stored. The on-screen-display contents can be stored in external data source 106 in any suitable ways. In one example, the actual on-screen-display contents, such as the on-screen-display content 118 of text “OSD TEXT” in on-screen-display region 116, can be stored in the external data source. In another example, the abstracted information of the on-screen-display contents can be stored in the external data source. The abstracted information of an on-screen-display content is referred to as a set of user-defined features, and instructions for combining the user-defined features so as to build the on-screen-display content. The abstracted information has a data size that is equal to or smaller than the data size of the actual on-screen-display content. For example, a set of basic features can be defined as a group of simple geometric figures, such as lines, rectangles, polygons, boxes, ellipses, texts, and combinations thereof. A set of instruction can include, but is not limited to, parameters of constructing a specific on-screen-display content using the user-defined basic features, such as the on-screen size, on-screen position, color, and other related information. The abstracted information of specific on-screen-display content can be obtained by an encoding unit based on an encoding scheme that corresponds to the decoding scheme in the display device (e.g. the language used in translating the abstracted information in data handler 104). The encoding unit can be a functional module embedded in the external data source, or can be a separate functional module connected to the external data source.

In the example as illustrated in FIG. 1, the abstracted information (as well as the actual data if desired) of on-screen-display content 118 of text “OSD TEXT” can be stored in external data source 106. In another example, the external data source can be used to store the abstracted information and specific contents, especially foreign figures that are difficult to be built using the user-defined basic features. As an aspect of the above example, a foreign figure can be processed as desired so as to reduce the data size of the foreign figure. For example, the actual picture of fire logo 182 as illustrated in FIG. 7 can be stored in the external data source. As another aspect of the above example, a foreign figure can be replaced by an approximate figure that is built using the user-defined basic features.

The on-screen-display content in external data source (106) is delivered to data handler 104 of the display device (100). In the example wherein the on-screen-display content stored in the external data source in its actual form, the data handler may directly forward such on-screen-display content to an input of multiplexer 108.

In the example wherein the abstracted information of the on-screen-display content is available in the external data source (106), the abstracted on-screen-display information is delivered to the data handler (104). The data handler (104) can translate the abstract information of the on-screen-display content, for example, into a set of translated information that is compatible with the display configuration of the display device (100). The translated information, as well as other data (such data other than closed-caption data) if provided, is passed to the OSD data logic (110) through multiplexer 108. The OSD data logic (110) can compose the desired on-screen-display content based upon the translated information. Specifically, the OSD data logic (110) can generate a set of caption data and store the generated caption data into an image buffer. The light valve of the display device can then retrieve the caption data from the image buffer and displays the desired on-screen-display using the caption data retrieved from the image buffer.

In the example wherein a foreign figure is stored in the external data source and is to be displayed on the screen as on-screen-display content, the foreign figure can be delivered to the data handler (104) that forwards the received foreign figure to the OSD data logic (110) through multiplexer (108). Alternatively, the foreign figure can be approximated by a replacement figure that can be composed using the set of user-defined features and instructions. The replacement figure can then be processed so as to obtain the abstracted information, for example, by the external data source or by a unit having a connection to the external data source. The abstracted information can then be delivered to the data handler (104).

The multiplexer (108) outputs one or both of the caption from the video decoder (102) and data handler (104). The output of the multiplexer is delivered to OSD data logic 110 that prepares the display data (e.g. image data) to be displayed on the screen (112) based upon the output of multiplexer.

In the example as diagrammatically illustrated in FIG. 1, a frame of video 114 is currently displayed on screen 112 of display device 100. An on-screen-display content 118 of text “OSD TEXT” is displayed on the screen (112) in the on-screen-display region 116. It is noted that the on-screen-display region can be at any desired positions on the screen (112). The on-screen-display content, as well as the on-screen-display region (116) can be displayed on the screen (112) in any desired orientation, such as horizontally (as shown in FIG. 1), vertically, or along any desired directions.

Because the on-screen-display content (118) displayed on the screen is delivered from or derived from the data stored in external data source 106; and the external data source can be controlled by users, any suitable contents can be displayed at any desired time on the screen (112) as on-screen-display contents.

In examples where the abstracted information of the desired on-screen-display content is delivered to the display device (e.g. the data handler of the display device), a low-speed connection means can be used to connect the device and the external data source, which in turn, reduces the cost of the display device in many aspects, such as in design, material, and manufacturing. Moreover, the abstracted information can be transmitted to the display device (100) from the external data source in a more efficient, reliable, and possibly faster way as compared to the transmission of the actual on-screen-display content with a larger data size.

As discussed above, the external data source can be implemented in many ways, one of which is a device connected to the data handler through a network. In this example, the data handler is provided with network connectivity as diagrammatically illustrated in FIG. 2.

In the example as shown in FIG. 2, data handler 104 comprises logic 120 and Ethernet controller 122 that is connected to standard RJ45 Ethernet jacket 124. The logic (120) is provided for processing the received data, such as translating the abstracted information of on-screen-display content data. The Ethernet jacket (124) is connected to network 126 through an Ethernet cable. Server 128 is connected to the data handler through the network 126. The Ethernet controller can be embedded in the data handler or alternatively, can be a separate member connected to the data handler. With this configuration, on-screen-display content can be delivered from the server (128) to the data handler (104) through the network (126). Because the abstracted information of the on-screen-display contents are delivered to the data handler (104) from the server, the Ethernet controller (122) and logic 120 of the data handler can be connected by a low-speed connection means, such as a serial connection or a universal-asynchronous-receiver/transmitter (UART) connection.

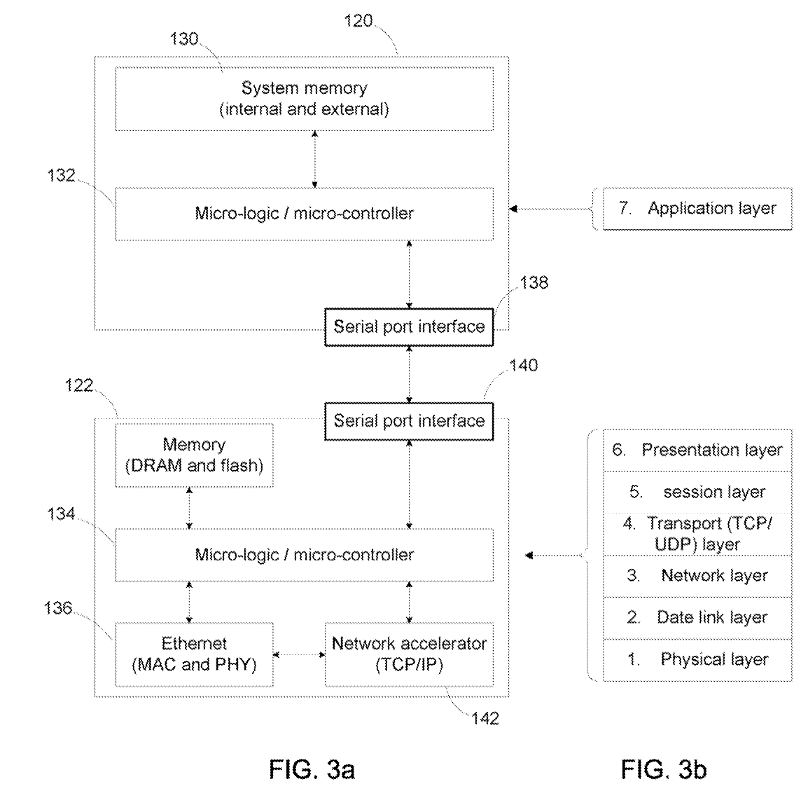

Depending upon different applications and/or network connections, the logic and the Ethernet controller can be implemented in many different ways, one of which is diagrammatically illustrated in FIG. 3a and FIG. 3b. Referring to FIG. 3a and FIG. 3b, FIG. 3b shows a protocol stack of an exemplary network implementation. This protocol stack comprises seven layers—the physical layer, the data link layer, the network layer, the transport (TCP/UDP) layer, the session layer, the presentation layer, and the application layer.

The first 6 layers (from the physical layer to the presentation layer) are implemented in the Ethernet controller (122). Accordingly, the Ethernet controller (122) as shown in FIG. 3a comprises Ethernet module 136 implemented therein support for the physical layer and the media-access-control layer, which is a sub-layer of the data link layer as shown in FIG. 3b. To accelerate the network connection, network accelerator based on TCP/IP 142 can be provided in the Ethernet controller 122. Micro-logic 134 of the data handler (122) can be used for extracting data, such as abstract information (or other data if necessary) from the network data stream. The extracted abstraction information can be output from serial port 140 to logic module 120. The data handler may comprise other functional components, such as on-chip memory 122.

The application layer of the protocol stack is implemented in the logic unit (120). The logic unit (120) receives the extracted abstracted information from serial port 138 that interfaces serial port 140 of the Ethernet controller (122). The received abstracted information is forwarded to on-chip micro-logic (or micro-controller) 132 that translates the abstracted information by using, for example, a translation language corresponding to the pre-determined decoding scheme. The micro-logic (132) can compose the on-screen-display content according to the translated abstracted information by generating a set of image data based on which the desired on-screen-display content can be displayed. The image data can be stored in system memory 130, which can be internal, external, or a combination thereof. During the display, the image data for the on-screen-display content can be retrieved from the system memory and delivered to the light valve for displaying the on-screen-display content. In this disclosure, a light valve is referred to a device that comprises an array of individually addressable pixels, such as micromirrors, liquid-crystal display cells, liquid-crystal-on-silicon display cells, plasma cells, organic-light-emitting-diodes, or other devices. In some examples such as scanning-display systems, images are generated by scanning a screen by light beams from an illumination system. In these examples, the image data for the on-screen-display contents are delivered to a light scan control unit that is provided in the display device for controlling the scan of the light beams in displaying videos.

It is noted that the implementation of the protocol stack in the Ethernet controller and the logic unit of the data handler is only one of many possible examples. Other configurations are also applicable. For example, the first layer (the physical layer) of the protocol stack is implemented in the Ethernet controller, while other protocol layers can be implemented in other logics in the data handler. In other examples, any suitable network protocols can be used and implemented in the display device.

It can be seen in FIG. 3a and FIG. 3b that the protocol stack is implemented in separate functional components—the Ethernet controller and the logic unit of the data handler. Because the application layer, which is implemented in the logic unit (120), the logic unit (120) may be configured specifically for the particular display device. In contrast, the first six layers from the physical layer to the presentation layer of the protocol stack are implemented in the Ethernet controller (122). The Ethernet controller (122) can be configured independent from the specific configuration and setup of the display device. In other words, the Ethernet controller can be designed and installed independent to the display device.

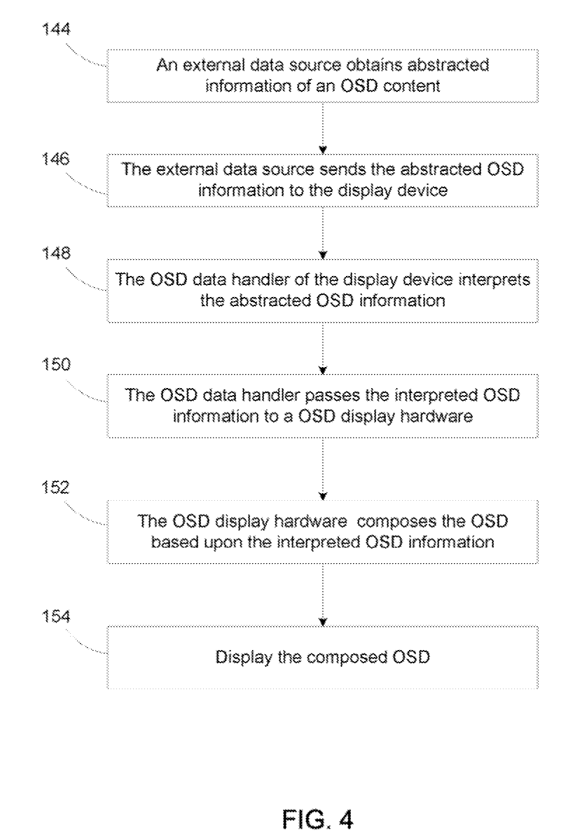

For demonstration purposes, an exemplary operation of dynamic on-screen-displaying is shown in the flow chart in FIG. 4. Referring to FIG. 4, the abstracted information of an on-screen-display content to be displayed is obtained by an external data source (step 144). In particular, the abstracted information can be obtained from a network, such as Internet, when the display device is connected to a network. The abstracted information is delivered to the display device, such as to the data handler (104 in FIG. 1 and FIG. 2) of the display device (step 146). The data handler translates the abstracted information (step 148) and passes the translated information to an on-screen-display hardware (e.g. OSD data logic 110 in FIG. 1 and FIG. 2). The on-screen-display hardware composes the on-screen-display content using the translated information by generating a set of image data for the composed on-screen-display content. As an alternative feature, the image data for the composed on-screen-display data can be stored in an image buffer. During the display stage, the image data can be retrieved from the image buffer and displayed on the screen (step 154).

The display device as discussed above can be implemented in many fields, and can be of great value when multiple display devices are connected by a network. The network can be of various scales, connection methods, and architectures. For example, the display device can be a member of a personal-area-network (PAN), local-area-network (LAN), campus-area-network (CAN), metropolitan-area-network (MAN), wide-area-network (WAN), global-area-network (GAN), internetwork, intranet, extranet, internet, or a network of any combinations thereof. The network can be a network with an infrastructure or an ad hoc network. Depending upon the desired network connection method, the network can employ connections of Ethernet, optical fiber, wireless LAN, Home PAN, and/or power-line communication.

In a particular example, the display device as discussed above can be a member of a campus network or a corporate network. In a typical campus or corporate setup, a display device is often installed in each classroom of a campus or conference room in the corporate. The display device with the networking capability as discussed above enables centralized remote control and management through one or more networks. For example, the display-network controller (128) as illustrated in FIG. 2 can be implemented in a network server; and the display devices with the networking capability can be installed in the classrooms or the conference rooms. The display devices and the network server can be connected through one or more networks. With this configuration and the networking capability of the display devices, a user can control and monitor each display device remotely.

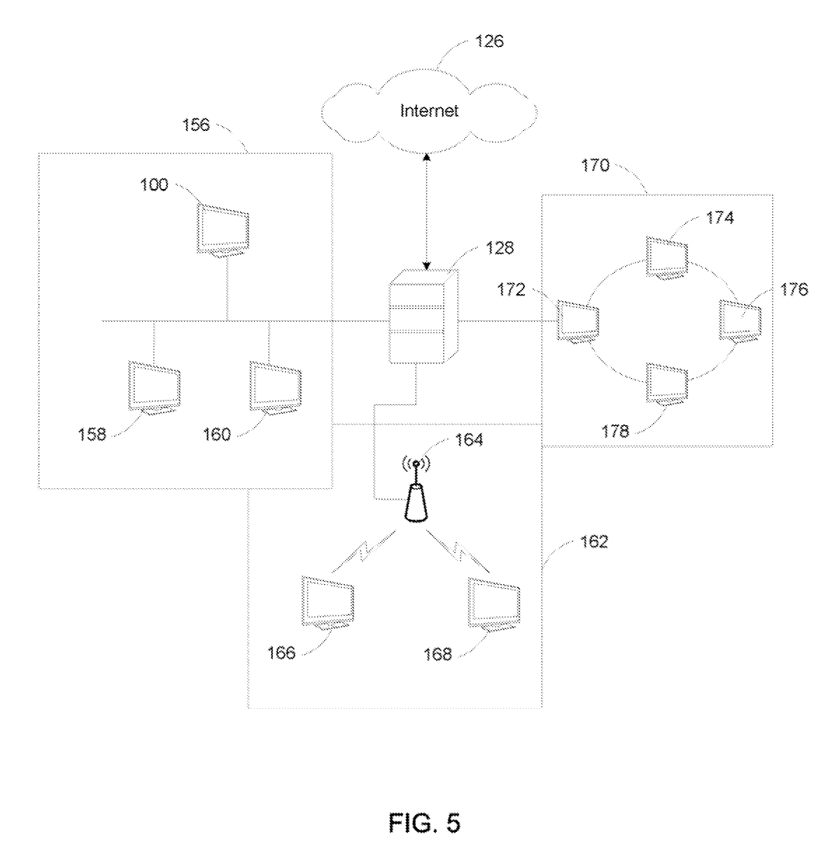

As a way of example, FIG. 5 diagrammatically illustrates an exemplary network in which the display device of this disclosure can be implemented. Referring to FIG. 5, the network comprises network server 128 that is connected to internet 126. Sub-nets 156, 170, and 162 are connected to the network server (28). Subnet 156 has a bus-topology with display devices 100 and other terminal-devices such as devices 158, and 160. The terminal-devices 158 and 160 can be the display devices of this disclosure or can be other devices, such as computing devices.

Sub-net 170 has a ring-topology with terminal-devices 172, 174, 176, and 178. Each one or all of the terminal-devices of sub-net 170 can be a display device of this disclosure or can be other devices, such as computing devices. Sub-net 162 is a wireless subnet having an access point (164) and terminal-devices 166 and 168. The terminal-devices 176 and 178 each can be the display device of this disclosure or can be other devices, such as computing devices.

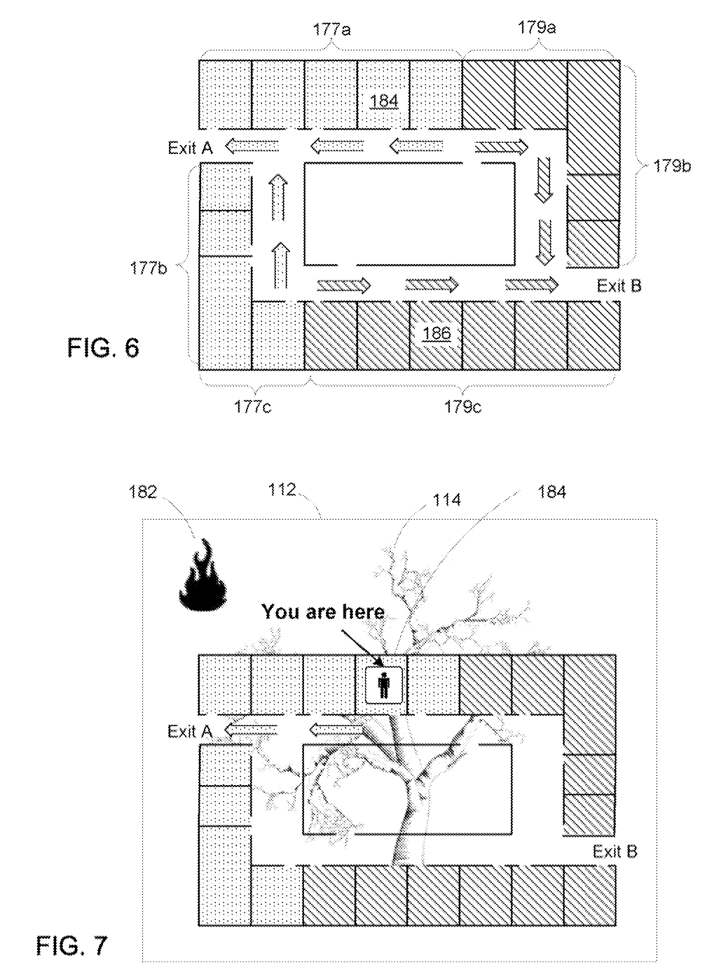

When connected to a network, the display devices of this disclosure enables different on-screen-display contents to be presented independently on different display devices. In particular, location-specific on-screen-display contents can be delivered to and displayed on display devices at different locations. As an example in a campus building, a display device can be installed in each classroom. The display devices are connected by a network, such as the sub-net (156) in FIG. 5; and each display device is assigned with a unique IP address (or network address). Because display devices are located in different classrooms (or other locations) and each display device can be identified by its unique network address, on-screen-display content for a specific display device can be delivered to and displayed by the intended display device. This feature can be of great importance in many applications, such as evacuation processes as diagrammatically illustrated in FIG. 6 through FIG. 8.

Referring to FIG. 6, an exemplary evacuation floor plan of a building floor in a campus building is illustrated therein. Each classroom can have a display device of this disclosure and the display devices are connected by a network. A network server or a control unit can be connected to the network for controlling and monitoring the display devices in the network.

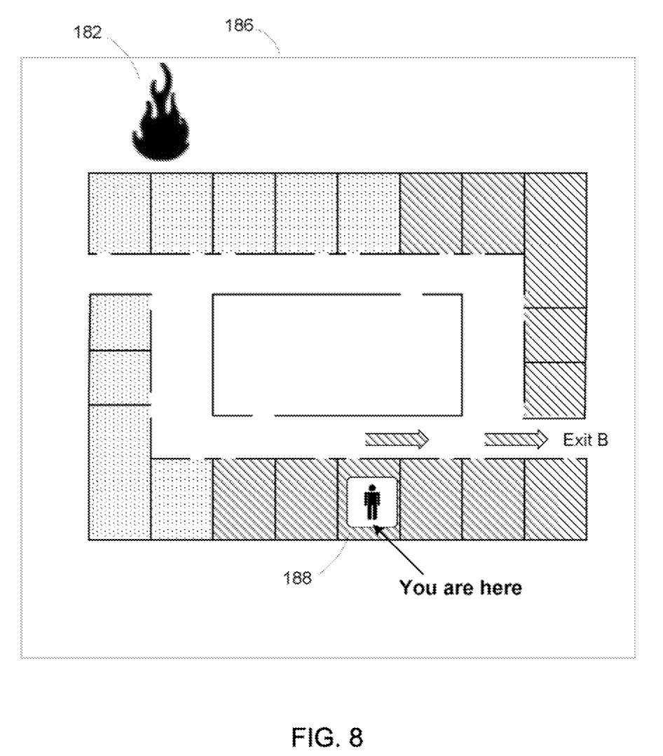

In case of emergency, people in different classrooms are expected to follow different evacuation routes as shown in FIG. 6. Specifically, people in classrooms 177a, 177b, and 177c are expected to move towards exit A along different routes represented by the arrows to evacuate the building. People in classrooms 179a, 179b, and 179c are expected to move toward exit B along different routes shown by the arrows to evacuate the building. Given the networked displayed devices, different evacuation floor plans can be displayed on display devices according to their specific locations. For example, different evacuation floor plans can be displayed on display devices in classrooms 184 and 186 because of their different locations and evacuation routes, as diagrammatically illustrated in FIG. 7 and FIG. 8.

Referring to FIG. 7, an evacuation floor plan is displayed as on-screen-display content on screen 112 of the display device installed in classroom 184. The evacuation plan may show the evacuation route specifically for classroom 184, such as without showing other information irrelevant to the evacuation for classroom 184. The evacuation plan may also show an icon of “You are here” to alert the people in classroom 184 of their location. Other information, such as fire icon 182 can be shown in event of fire alarm.

The evacuation plan particularly for classroom 188 is diagrammatically illustrated in FIG. 8. People in classroom 188 move towards exit B along the route indicated by the arrows during emergency. Other information, such as the location indicator of “You are here” and fire icon 182 can alternatively be shown in the evacuation plan.

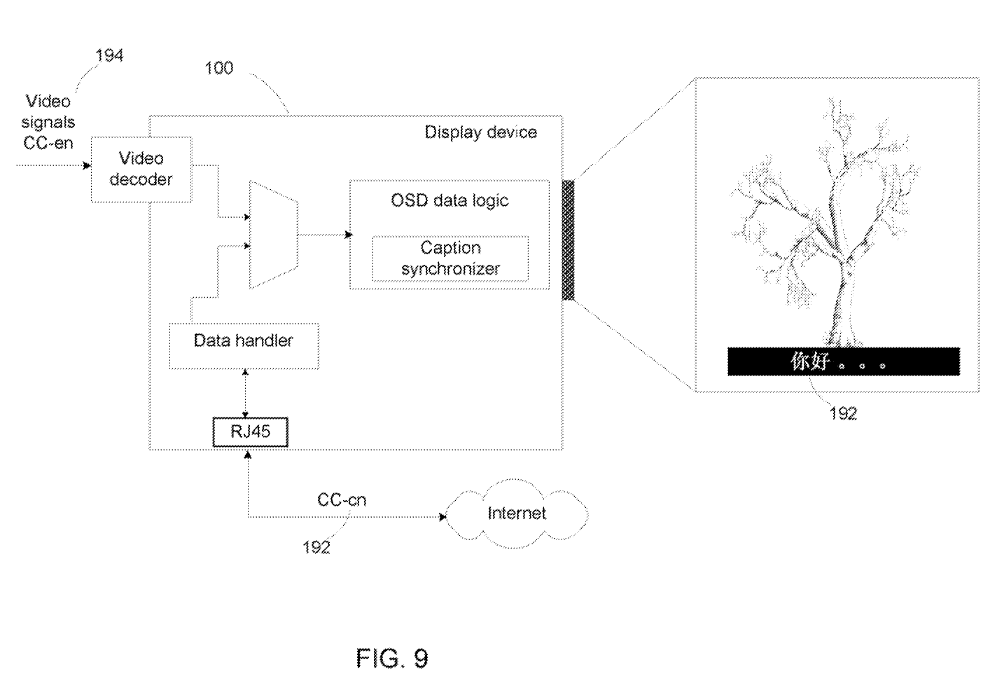

Another application of the display device of this disclosure is to display video captions different than the video captions carried by the input video streams. For example, captions of a second language (e.g. Chinese or Spanish etc.) can be displayed as on-screen-display content for displayed videos having embedded captions of a first language, such as English. For demonstration purpose, FIG. 9 diagrammatically demonstrates such caption display.

Referring to FIG. 9, input video streams carry video captions of a first language, such as English. A viewer speaking a non-English language, such as Chinese or Spanish, may want to use captions of the second language (e.g. Chinese or Spanish) for the displayed video. The captions (192) of the second language for the specific video can be downloaded from external data sources, such as the Internet.

The captions of the second language for the video can be delivered to the data handler of the display device as discussed above. The data handler can process the downloaded captions and forward the processed captions to the multiplexer. The multiplexer can select the captions from the data handler and pass such captions to the OSD data logic of the display device. The captions embedded in the input video streams may be blocked by the multiplexer and thus, may not be displayed on the screen.

Because the captions downloaded from the network (e.g. the Internet) are not synchronized with the video to be displayed, a caption synchronizer can be provided in the OSD data logic for synchronizing the downloaded captions with the video frames of the video to be displayed. After synchronization, the downloaded captions 192 can then be displayed on the screen as on-screen-display contents and synchronized with the video frames.

In another example, multiple display devices of this disclosure are installed in different physical locations, such as at different homes. Different on-screen-display contents, such as captions of different languages but for the same video program (e.g. a movie), can be delivered to and displayed by the different display devices. This can be especially useful when viewers of the different display devices at the different homes speak or prefer captions of different languages.

It will be appreciated by those of skill in the art that a new and useful method of presenting on-screen-display contents and a display device using the same have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

We claim:

1. A method for displaying an on-screen-content in a display device, the method comprising:
obtaining an abstracted information of the on-screen-display content such that the abstracted information has a data size that is equal to or smaller than the data size of the on-screen-display content;
delivering the abstracted information to the display device;
building the on-screen-display content from the abstracted information; and
displaying the built on-screen-display content on a screen.

2. The method of claim 1, further comprising:
receiving a stream of video signals;
obtaining a set of captions for the video stream from an internet; and
displaying the video streams and the captions for the video stream.

3. The method of claim 1, wherein the step of building the on-screen-display content comprises:
translating the abstracted information such that the translated information is specific to the display device; and
generating a set of image data for the on-screen-display content based upon the translated information.

4. The method of claim 3, comprising:
storing the image data for the on-screen-display content into an image storage; and
wherein the step of displaying the built on-screen-display content comprises:
retrieving the image data for the on-screen-display content from the image storage; and
displaying the on-screen-display content using the retrieved image data.

5. The method of claim 3, wherein the step of obtaining the abstracted information comprises:
abstracting the on-screen-display content so as to obtain the abstracted information of the on-screen-display content from a network device that is connected to the display device through a network.

6. The method of claim 5, wherein the network device is a network server that is capable of controlling and monitoring an operation of the display device.

7. The method of claim 5, wherein the display device comprises an Ethernet controller that is connected to the network.

8. The method of claim 7, wherein the Ethernet controller is further connected to a logic of the data handler of the display device.

9. The method of claim 8, wherein the Ethernet controller has at least the physical layer of the internet protocol implemented therein; and wherein a logic of the data handler has at least the application layer of the internet protocol implemented therein.

10. The method of claim 8, wherein a data connection between the logic of the data handler and the Ethernet controller has a lower data transmission speed than a connection between the Ethernet controller and the network.

11. The method of claim 5, wherein the on-screen-display content is a stream of video captions that is different from a stream of video captions carried by a stream of video signals being displayed by the display device.

12. The method of claim 11, wherein the video captions displayed as the on-screen-display content are of a language that is different from a language of the video captions carried by the video signals being displayed by the display device.

13. A method for use in a network that comprises first and second display devices that are at different physical locations and are connected to the network, the method comprising:
delivering first and second on-screen-display contents to the first and second display device, wherein the first and second on-screen-display content are not carried by and are separate from video signals being displayed by the first or the second display device; and
displaying the first and second on-screen-display contents by the first and the second display devices.

14. The method of claim 13, wherein the first and second on-screen-display contents are different.

15. The method of claim 14, wherein the first on-screen-display content is specific to the physical location of the first display device; and the second on-screen-display content is specific to the physical location of the second display device.

16. The method of claim 15, wherein the first on-screen-display content is an evacuation plan for the physical location having the first display device; and wherein the second on-screen-display content is an evacuation plan for the location having the second display device.

17. The method of claim 13, wherein the step of delivering first and second on-screen-display contents to the first and second display device comprises:
obtaining first and second sets of abstracted information from the first and second on-screen-display contents; and
delivering the first and second sets of abstracted information to the first and second display devices.

18. The method of claim 17, wherein the step of obtaining the first and second sets of abstracted information comprises:
obtaining the first and second sets of abstracted information by a network device connected to the first and second display devices through the network.

19. The method of claim 18, wherein said network device is a network server capable of controlling and monitoring operation of the first and second display devices.

20. The method of claim 19, wherein the first and second display devices are located in different physical locations of an educational campus, or a business campus, or are located in different homes.

21. A system, comprising:
a display device, comprising:
a video decoder capable of receiving a stream of video signals to be displayed and decoding the stream of video signals;
a data handler capable of receiving an on-screen-display content from an external data source;
a multiplexer connected to an output of the video decoder and an output of the data handler; and
an on-screen-display data logic connected to an output of the multiplexer.

22. The system of claim 21, wherein the data handler comprises:
an interface capable of receiving an abstracted information of the on-screen-display content from the external data source; and
a logic capable of translating the abstracted information into a translated information that is compatible with the display device.

23. The system of claim 22, wherein the on-screen-display data logic comprises a storage storing a set of image data that are generated from the translated information for the on-screen-display content.

24. The system of claim 21, wherein the interface is an Ethernet controller.

25. The system of claim 24, wherein the application layer of the protocol stack is implemented in the logic of the data handler; and wherein the Ethernet controller has implemented therein the physical layer, the data link layer, the network layer, the transport layer, the session layer, and the presentation layer of the protocol stack.
